(19) United States
(12) Patent Application Publication
(10) Pub. No.: US 2025/0166860 A1
(43) Pub. Date: May 22, 2025

(54) Inertial Electrostatic Confinement Fusion Electrode

(71) Applicant: Clandestine Materials Detection, Inc., Monona, WI (US)

(72) Inventor: Richard L. R. Bonomo, Madison, WI (US)

(73) Assignee: Clandestine Materials Detection, Inc., Monona, WI (US)

(21) Appl. No.: 18/514,212

(22) Filed: Nov. 20, 2023

(51) Int. Cl. G21G 4/02

(52) U.S. Cl. CPC G21G 4/02

(57) ABSTRACT

An inertial electrostatic confinement fusion electrode assembly for a neutron generator has a cathode which is suspended within an anode within a vacuum chamber. Each electrode is 3D printed of metal such as a titanium alloy to have multiple bar segments which define multiple adjacent cells, for example an arrangement of hexagons and pentagons. The cathode and the anode are aligned such that each cell of the anode overlies a cell of the cathode. The anode has a torus-like mounting rim which supports multiple bar segments. The mounting rim has a central opening through which a down connector extends to the cathode. The mounting rim is engageable for supporting the anode within a vacuum chamber. The bar segments of the cathode have a radial thickness greater than the bar segments of the anode. The electrodes have shapes approximating a sphere or geodesic polyhedron.

### BACKGROUND OF THE INVENTION

The present invention relates to Inertial Electrostatic Confinement (“IEC”) nuclear fusion devices, especially in connection with their use as neutron generators in mobile applications, and more particularly to the design of the electrodes used therein.

In U.S. Pat. No. 10,136,458, the disclosure of which is incorporated by reference herein, a system is disclosed for using an aerial-drone-mounted neutron generator to produce a stream of neutrons which can be directed towards areas where explosive devices are buried or otherwise hidden. When stimulated by the emitted neutrons, hidden explosives emit radiation which is detected and triangulated by multiple radiation sensors. The neutrons are generated using inertial electrostatic confinement fusion electrodes. Such neutron generators may or may not contain a radioactive source depending on the choice of fusion fuel.

An IEC-based neutron generator will typically have a pair of inertial electrostatic confinement (IEC) fusion electrodes contained within a vacuum chamber. The electrodes may be assembled from conductive wires formed into generally spherical cages or grids. The cathode cage is suspended within the anode cage within the vacuum chamber. Fusion fuel, such as deuterium gas, is introduced into the vacuum chamber and a voltage is applied across the electrodes which causes the deuterium to ionize. The deuterium may be ionized by other means as well. The positive ions fall towards the negative cathode. Colliding ions fuse to produce neutrons which then pass out of the outer anode cage and through the walls of the vacuum chamber. However, the likelihood of ions impacting one another is extremely low, requiring the ions to recirculate thousands or millions of times before impacting either of the electrodes. A very large number of neutrons is required to satisfactorily impact all the explosive material in the area being assessed, so it is desirable that the IEC device be very efficient in generating neutrons.

Conventional IEC electrodes may be formed of metal wires arranged to define cells of various shapes. If the openings of the inner cathode are not coherent with the openings of the anode, the recirculating ions and freed electrons are more likely to strike a wire, thereby reducing the total neutron emission count and heating the electrode wires.

A truncated icosahedron is a shape having a surface comprised of hexagons and pentagons, and is a highly symmetric shape found naturally in the structures of fullerenes, for example C₆₀. US 2018/0033496 discloses a continuous electrode IEC device having a single element with an array of cells defined by internal walls whose exterior edges define an irregular truncated icosahedron configuration. Electrodes are coupled to the walls “in order to provide an electric field that varies along the particle paths, for example from a radially-outer anode region (remote from the central core) to a radially-inner cathode region (proximal to the central core).” This device, intended to serve as a fusion device for electricity generation or for spacecraft propulsion, is complicated and has a semiconductor composition with multiple layers to control the voltages over the lengths of each cell wall.

While neutron generators in the laboratory can be fixed in place and isolated against shock and vibration, neutron generators aboard an aircraft will be subject to much higher levels of shock and vibration. Conventional IEC electrodes formed of wire are of limited stiffness and can become extremely hot during the production of neutrons. What is needed is a robust IEC electrode arrangement which is effective at radiating excess heat, is structurally stiff enough to endure aerial use yet which effectively allows the efficient production of neutrons.

### SUMMARY OF THE INVENTION

The inertial electrostatic confinement fusion electrode assembly of the invention has two cage-like electrodes which approximate the shape of a sphere or a geodesic polyhedron. The outer electrode or anode has a torus-like anti-coronal mounting rim for attachment to a wall of the vacuum vessel. The torus-like ring on the top serves to reduce the possibility of arcing from the down conductor to the anode, and may also be used to facilitate mounting. The inner electrode or cathode is suspended within the anode on a rod-like down conductor. The electrodes are made up of multiple bar segments arranged to define polygonal cells, such as an arrangement of hexagons and pentagons. The electrodes may be 3D printed of titanium or a titanium alloy, a refractory metal or, in the case of the anode, stainless steel. The cathode and the anode are aligned such that each cell of the outer electrode overlies a cell of the inner electrode. The bar segments of the cathode have a radial thickness greater than the bar segments of the anode, promoting effective heat dissipation. Each electrode may be formed of two halves which are welded or mechanically connected to one another.

It is an object of the present invention to provide inertial electrostatic confinement fusion electrodes which have coherent cages for efficient neutron production.

It is an object of the present invention to provide inertial electrostatic confinement fusion electrodes which are stiff enough to withstand flight aboard an aerial drone or other mobile platforms that may subject payload to vibration or substantial accelerations.

It is an object of the present invention to provide inertial electrostatic confinement fusion electrodes which avoid overheating.

Further objects, features and advantages of the invention will be apparent from the following detailed description when taken in conjunction with the accompanying drawings.

### BRIEF DESCRIPTION OF THE DRAWINGS

FIG. 1 is a partially schematic cross-sectional view of the inertial electrostatic confinement fusion electrodes of this invention enclosed within a vacuum chamber of a neutron generator.

FIG. 2 is a fragmentary cross-sectional partially schematic view of the arrangement of FIG. 1.

FIG. 3 is an alternative embodiment arrangement of inertial electrostatic confinement electrodes having an anode with a mounting torus which is continuous with a cylindrical support frame.

FIG. 4 is a fragmentary isometric view of flat-wire-connected anode halves of the invention.

FIG. 5 is a side elevational view of the upper anode half of the device of FIG. 1.

FIG. 6 is a side elevational view of the lower anode half of the device of FIG. 1.

FIG. 7 is a side elevational view of the upper cathode half of the device of FIG. 1.

FIG. 8 is a side elevational view of the lower cathode half of the device of FIG. 1.

### DESCRIPTION OF THE PREFERRED EMBODIMENTS

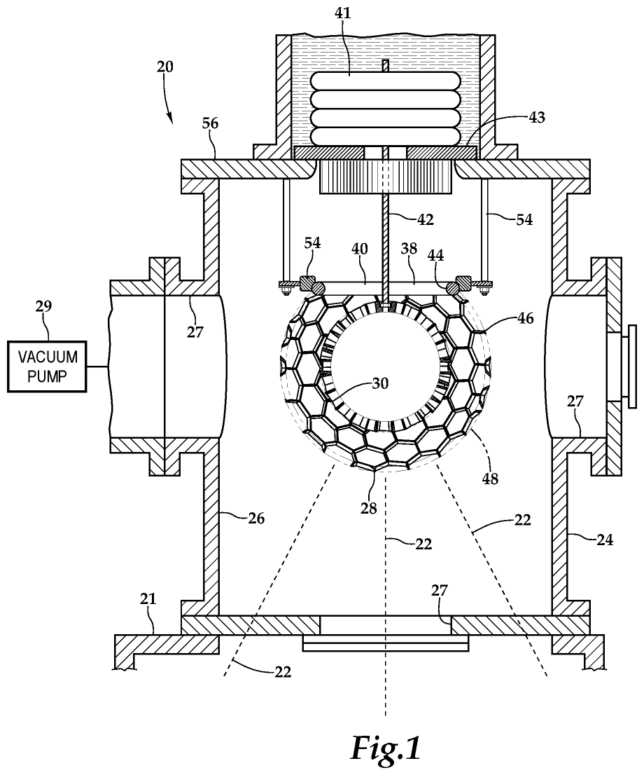

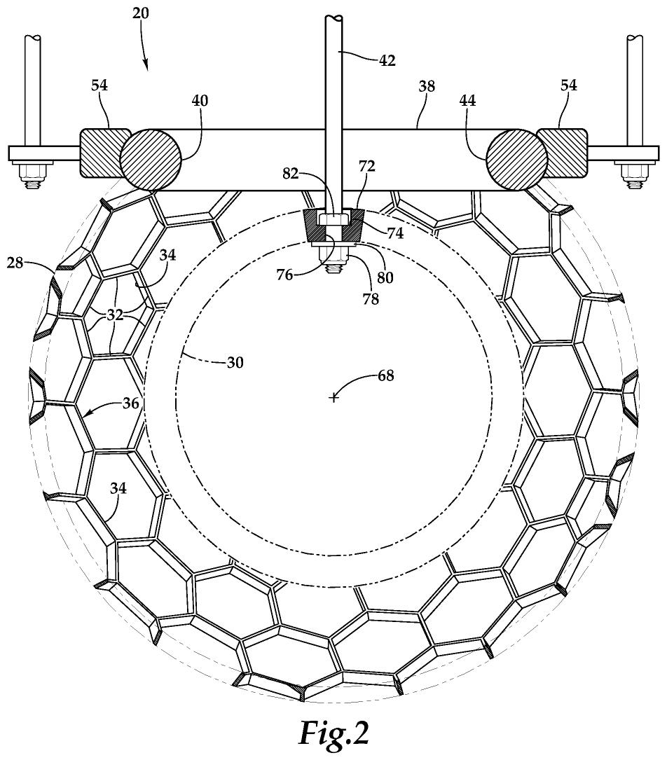

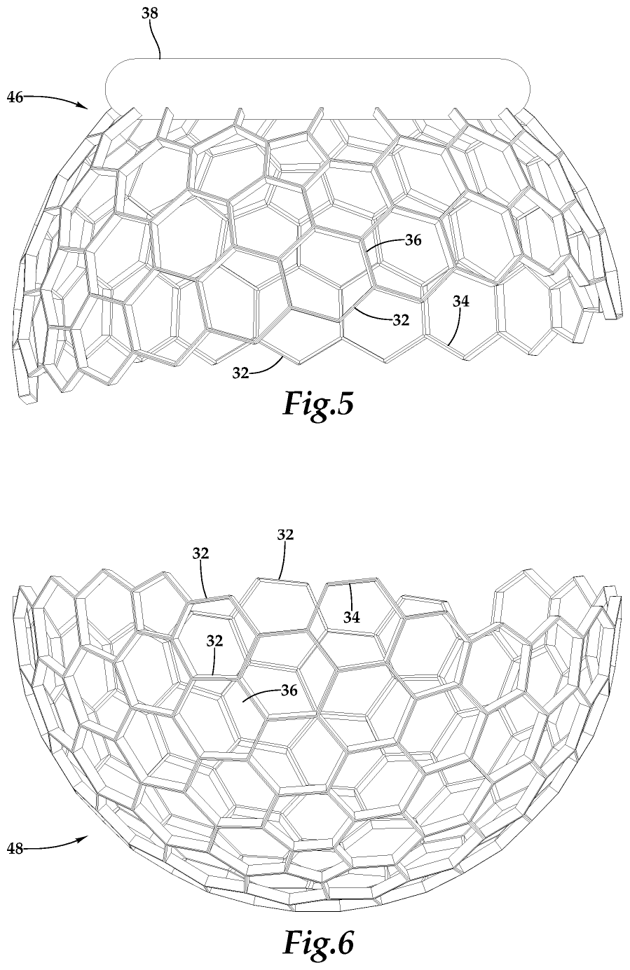

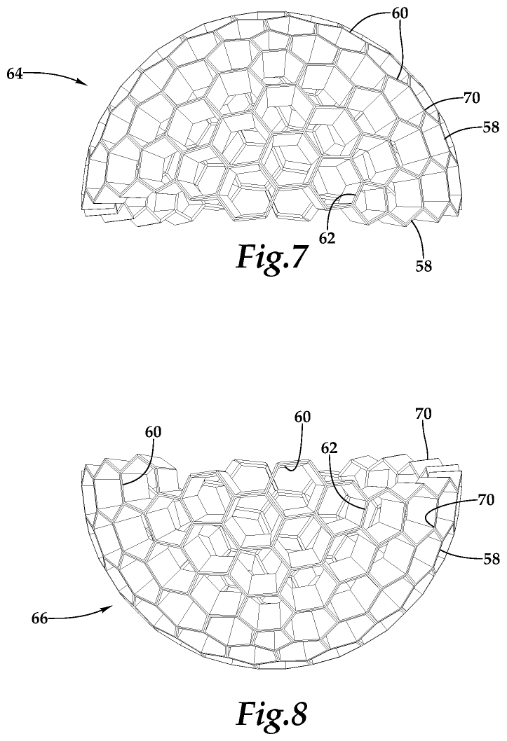

Referring more particularly to FIGS. 1-8 wherein like numbers refer to similar parts, a neutron generator 20 is shown in FIG. 1. The neutron generator 20 is mounted to a frame 21 of an aerial drone or other vehicle and serves as a source of neutrons 22 for detecting explosives. The neutron generator 20 has a vacuum vessel 24 which defines a sealed vacuum chamber 26. The inertial electrostatic confinement electrodes are suspended within the vacuum chamber 26 and include an outer anode 28 shown in FIGS. 5 and 6, and an inner cathode 30, shown in FIGS. 7 and 8. For simplicity, the cathode is shown schematically in FIGS. 1 and 2. The vacuum vessel 24 has a number of ports 27 for access to the vacuum chamber 26. A vacuum pump 29 is shown connected through a port 27 to evacuate the vacuum chamber 26. The flyable vacuum vessel may dispense with a vacuum pump, and may have fewer ports than illustrated.

As shown in FIG. 2, the anode 28 has a multiplicity of bar segments 32 which are joined together to define a plurality of cells 34. The bar segments 32 define a cage like structure with an orderly array of openings 36. The cells 34 are preferably polygonal, for example hexagons and pentagons, which define an approximately spherical surface, preferably a geodesic polyhedron such as an irregular truncated icosahedron. The anode 28 has a mounting rim 38 which supports the multiplicity of bar segments 32. The anode mounting rim 38 is positioned above the cathode 30 and has a circular central opening 40. The central opening 40 is configured to receive a down conductor 42 which is a metal lead extending downwardly to the cathode 30. The mounting rim 38 may define a torus which has a continuous curved inwardly facing surface 44. The continuous curve of the surface 44 desirably avoids any edges or discontinuities which would promote arcing from the high negative voltage in the down conductor 42 as it passes through the opening 40. The anode 28 and cathode 30 are positioned about a common center 68. The torus of the anode mounting rim 38 has a center which is positioned about a center line which intersects the common center 68.

Although shown as a single element for simplicity in FIGS. 1 and 2, the anode 28 is preferably 3D printed from stainless steel, titanium or a titanium alloy, and fabricated as multiple parts to facilitate assembly of the cathode 30 inside the anode. The anode 28 may thus have an upper half 46, shown in FIG. 5, which is formed to extend downwardly from the torroidal mounting rim 38, and a lower half 48, shown in FIG. 6, which is beneath the first half and removably secured thereto. As shown in FIG. 4, the lower half 48 may be connected to the upper half by thin flat stainless steel wire 50 which is wrapped around adjacent bar segments of adjacent anode cells 34 of the upper and lower halves. The wire 50 is wrapped in such a way that any free ends of the wire are on the exterior of the anode 28 to avoid arcing. The lower half 48 of the anode 28 may be separated from the anode upper half 46 for the insertion and removal of the cathode 30 from between the anode halves 46, 48.

As shown in FIG. 1, the anode may be supported within the vacuum chamber 26 by inwardly extending clamps 54 which are fixed to the overlying cover 56 of the vacuum vessel 24 and which engage the mounting rim 38. The anode 28 is thus grounded to the vacuum chamber 26. The down conductor 42 will extend through a ceramic insulator 41 and extends through a plate which is a portion of a feed-through 43 into the vacuum chamber 26. Other methods of fastening the anode to the vacuum vessel and maintaining alignment to the cathode may be employed.

As shown in FIGS. 7 and 8, the cathode 30 has a multiplicity of bar segments 58 which are joined together to define a plurality of cells 60. The bar segments 58 define a cage like structure with an orderly array of openings 62. The cathode cells 60 define polygons which are similar in shape and aligned with the cells 34 of the anode as discussed below. The cathode 30 may be 3D printed as a single part, or may be formed as an upper half 64, shown in FIG. 7, which is welded to a lower half 66, shown in FIG. 8. The cathode 30 is formed of electrically conductive metal, preferably of titanium or a titanium alloy such as a titanium aluminum vanadium alloy such as Ti-6Al-4V. The cathode 30 will be maintained at a high negative voltage with respect to the anode 28. To dissipate heat, the bar segments 58 of the cathode 30 have a thickness in a radial direction extending outwardly from the common center 68 of the two electrodes of about ½ inch. This thickness gives structural integrity to the cathode, and has a higher heat capacity and allows more heat rejection. The anode bar segments 32 will not experience high heat flows, and thus need not be as thick, and may have a radial thickness of ¼ inch. The cathode bar segments 58 may have a radial thickness at least twice the radial thickness of the anode bar segments 32. Each bar segment has a width in a circumferential direction perpendicular to the radial direction, and this width may be constant on the anode and the cathode respectively. Thus an imaginary plane through the center of each bar segment intersects the common center of the nested cathode and anode.

To facilitate optimal generation of neutrons 22, it is desirable that the radial paths of the recirculating ions and any generated neutrons encounter as few obstructions as possible. Hence the anode 28 is aligned with the cathode 30 such that each anode cell 34 is positioned to overlie a cathode cell 60. The two electrodes 28, 30 are positioned so that each anode cell 34 overlies a cathode cell 60 with a like number of sides. The outer anode cells 34 are larger than the inner cathode cells which they overlie, but each anode cell has a center which overlies a center of an underlying cathode cell 60 and is positioned so an imaginary radial line extends from the common center 68 through the two cell centers. The cells 34 of the anode are formed by the bar segments 32 coming together at a vertex 52 with two other bar segments (except at the margin of the halves 46, 48 where the vertices have only two joined segments). The cells 60 of the cathode are likewise formed by bar segments 58 which come together at a vertex with two other bar segments (except at the margin of the halves 64, 66, where the vertices have only two joined segments). Because the anode and the cathode are coherent, each anode vertex 52 has a radially extending center line which substantially aligns with a radially extending center line which extends through a cathode vertex 70. This coherent arrangement of the anode 28 with respect to the cathode 30 gives a radial path for recirculating ions, and generated neutrons. It should be noted that some slight variance from a precise alignment of the vertices may be experienced when the halves of the cathode and anode are assembled due to the doubled thickness of the bar segments at the joints as shown in FIG. 4, but the vertices will still be considered to be substantially aligned. Fabrication techniques may eventually allow the bar segments at the joints to be made with half thickness to avoid this.

As shown in FIG. 2, the upper half 64 of the cathode 30 has a topmost hexagon 72 with a mounting flat region 74 with a radial threaded cylindrical mounting hole 76 therein. The end of the down conductor 42 is threaded to receive a an optional nut 78 on the interior of the upper half 64. A washer 80 and lock nut 82 are secured on the down conductor 42 on the interior of the cathode. A tool may be inserted through one of the hexagonal openings 62 in the cathode 30 on the cathode lower half 66 to adjust and secure the lock nut 82 on the down conductor 42 to secure the cathode when it is aligned with the anode 28.

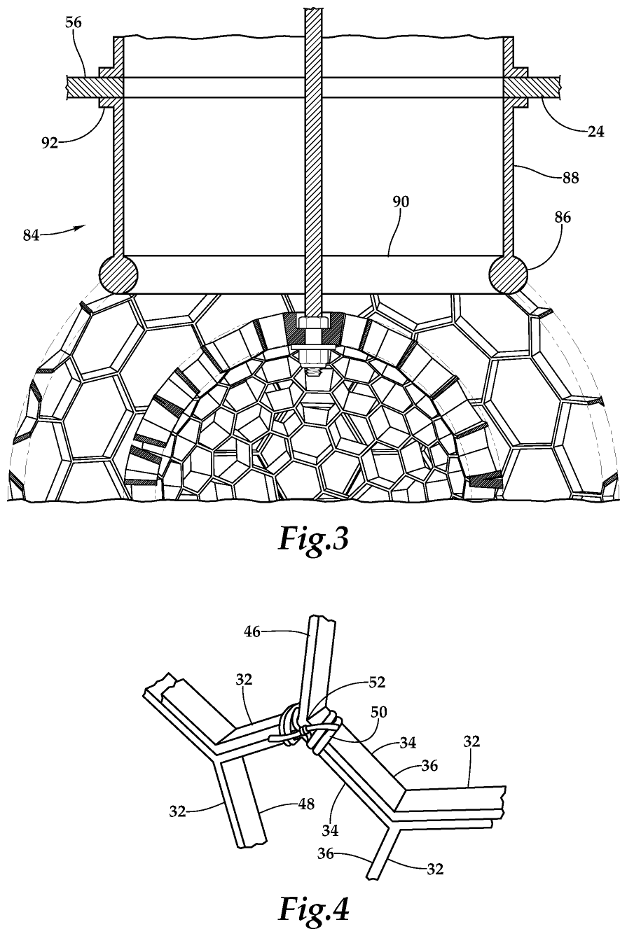

An alternative embodiment anode 84 is shown in FIG. 3 in which the mounting rim 86 is 3D printed with a cylinder 88 extending upwardly from a torus 90 and terminating in an upper flange 92 which is mounted directly to the cover 56 of the vacuum vessel 24. In this embodiment no clamping of the anode is required.

It is understood that the size and number of cells in the electrodes may be varied, and that the shapes of the cells may be other than pentagons and hexagons.

It is understood that the invention is not limited to the particular construction and arrangement of parts herein illustrated and described, but embraces all such modified forms thereof as come within the scope of the following claims.

I claim:

1. An inertial electrostatic confinement fusion electrode assembly comprising:
a first electrode comprised of a multiplicity of first bar segments which are joined together to define a plurality of first cells;
a second electrode positioned within the first electrode, the second electrode comprised of a multiplicity of second bar segments which are joined together to define a plurality of second cells;
wherein the first electrode is aligned with the second electrode such that each first cell of the first electrode is positioned to be spaced radially outwardly of a second cell of the second electrode; and
a mounting rim which supports the multiplicity of first bar segments, the mounting rim being positioned above the second electrode and having a central opening configured to receive an electrical conductor extending to the second electrode, wherein the mounting rim has a continuous curved surface which faces inwardly, the mounting rim being engageable for supporting the first electrode within a vacuum chamber. 2, The assembly of claim 1 wherein the plurality of first cells are polygonal and wherein the plurality of second cells are polygonal, and each first cell overlies a second cell of a like number of sides.

3. The assembly of claim 2 wherein each first cell is a pentagon or a hexagon.

4. The assembly of claim 1 wherein the first electrode and the second electrode are positioned about a common center, and wherein each first bar segment has a first radial thickness and a first width perpendicular to the radial thickness, and wherein each second bar segment has a second radial thickness which is greater than the first radial thickness.

5. The assembly of claim 1 wherein the second radial thickness is at least twice the first radial thickness.

6. The assembly of claim 2 wherein each first bar segment is connected to two other first bar segments at a first vertex, and wherein each second bar segment is connected to two other second bar segments at a second vertex, and wherein each first vertex has a radially extending center line and each second vertex has a radially extending center line which aligns with a first vertex center line.

7. The assembly of claim 1 wherein the first electrode and the second electrode are positioned about a common center, and wherein each first cell has a first cell center and wherein each second cell has a second cell center and wherein each first cell center is positioned on an imaginary radial line which extends from the common center through a second cell center and through said first cell center.

8. The assembly of claim 1 wherein the first electrode defines a first half which is formed to extend downwardly from the mounting rim, and a second half which is beneath the first half and removably secured thereto, such that the second half may be separated from the first half for the insertion and removal of the second electrode from between the first half and the second half.

9. The assembly of claim 1 wherein the first electrode and the second electrode are positioned about a common center, and wherein the mounting rim defines portions of a torus having a center which is positioned about a center line which intersects the common center.

10. The assembly of claim 1 wherein the first electrode and the second electrode are positioned about a common center, and wherein each first bar segment has a center plane passing through its center, and wherein each center plane intersects the common center.

11. The assembly of claim 1 wherein the second electrode is comprised of a titanium aluminum vanadium alloy.

12. The assembly of claim 1 wherein the mounting rim defines a torus.

13. The assembly of claim 1 further comprising a cylindrical wall which extends upwardly from the mounting rim which is configured for mounting to an overlying portion of a vacuum vessel.

14. An inertial electrostatic confinement fusion electrode assembly comprising:
a first electrode comprised of a multiplicity of first bar segments which are joined together to define a plurality of first cells, each first cell having a first center;
a second electrode positioned within the first electrode, the second electrode comprised of a multiplicity of second bar segments which are joined together to define a plurality of second cells, each second cell having a second center, wherein the first electrode and the second electrode are positioned about a common center;
wherein the first electrode is aligned with the second electrode such that each first cell of the first electrode is positioned to radially overlie a second cell of the second electrode, such that for each first cell, an imaginary line extends from the common center through a second cell and a center of said first cell; and
an upper rim which supports the multiplicity of first bar segments, the upper rim being positioned above the second electrode and having a central opening configured to receive an electrical conductor extending down to the second electrode.

15. The assembly of claim 14 wherein for each first cell, an imaginary line extends from the common center through a second center and through the first center of said first cell.

16. The assembly of claim 14 wherein the mounting rim has a continuous curved surface which faces inwardly, the mounting rim being engageable for supporting the first electrode within a vacuum chamber.

17. The assembly of claim 16 wherein the mounting rim defines a torus.

18. The assembly of claim 16 wherein each first bar segment has a first radial thickness and a first width perpendicular to the radial thickness, and wherein each second bar segment has a second radial thickness which is greater than the first radial thickness.

19. An inertial electrostatic confinement fusion electrode assembly comprising:
a first electrode comprised of a multiplicity of first bar segments which are joined together to define a plurality of first cells;
a second electrode positioned within the first electrode, the second electrode comprised of a multiplicity of second bar segments which are joined together to define a plurality of second cells, wherein the first electrode and the second electrode are positioned about a common center;
wherein the first electrode is aligned with the second electrode such that each first cell of the first electrode is positioned radially outwardly of a second cell of the second electrode;
wherein each first electrode first cell defines a plurality of first vertices where the first bars which make up a first cell join adjacent first bars, and wherein each second electrode second cell defines a plurality of second vertices where the second bars which make up the second cell join adjacent second bars, and wherein each first vertex is substantially radially aligned with a second vertex such that an imaginary line extends from the common center through said each first vertex and aligned second vertex; and
an upper rim which supports the multiplicity of first bar segments, the upper rim being positioned above the second electrode and having a central opening configured to receive an electrical conductor extending down to the second electrode.

20. The assembly of claim 16 wherein each first bar segment has a first radial thickness and a first width perpendicular to the radial thickness, and wherein each second bar segment has a second radial thickness which is greater than the first radial thickness.
